(19) United States
(12) Patent Application Publication
(10) Pub. No.: US 2026/0204118 A1
(43) Pub. Date: Jul. 16, 2026

(54) ARTICLE SUPPLY APPARATUS

(71) Applicant: BANDAI CO., LTD., Tokyo (JP)

(72) Inventors: Hajime KONDO, Tokyo (JP); Tatsushi IKARASHI, Tokyo (JP); Yoshiaki TATSUKI, Tokyo (JP); Nobuo KUROKAWA, Tokyo (JP)

(21) Appl. No.: 19/565,478

(22) Filed: Mar. 12, 2026

Related U.S. Application Data
(63) Continuation of application No. PCT/JP2024/041810, filed on Nov. 26, 2024.

(30) Foreign Application Priority Data
Nov. 30, 2023 (JP) 2023-203081

(51) Int. Cl. G07D 3/04

(52) U.S. Cl. CPC G07D 3/04

(57) ABSTRACT

An article supply apparatus includes: an insertion portion 5 to which a coin C is insertable; a first holding portion 25a and a second holding portion 25b capable of holding the coins C that are inserted; and sorting portion 26 which is provided between the insertion portion 5, and the first holding portion 25a and the second holding portion 25b, and which is capable of sorting the coin to a movement destination, and each of the first holding portion 25a and the second holding portion 25b includes a setting portion 28 capable of setting a number of at least one coin capable of being held, and the sorting portion 26 is configured, on a condition that the first holding portion 25a is holding a set number of the coins, to be capable of sorting the coin that is inserted thereafter to be held in the second holding portion 25b.

The contents of the following patent application(s) are incorporated herein by reference:

NO. 2023-203081 filed in JP on November 30, 2023, and

NO. PCT/JP2024/041810 filed in WO on November 26, 2024.

### BACKGROUND

### 1. TECHNICAL FIELD

The present invention relates to an article supply apparatus.

### 2. RELATED ART

In the related art, there are various types of article supply apparatuses (vending machines) for automatically selling products. The article supply apparatus is provided with a function to sort a coin required as price payment for purchasing products. For example, Patent Document 1 discloses a configuration to provide a chute between a collected coin discharge opening and a change returning discharge opening of the coin discriminator, and a safe and a return opening, and to provide, in the chute, a partition plate for sorting the change to the return opening or the safe according to the purpose of use.

### Related Art Documents

### Patent Document

Patent Document 1: Japanese Patent Application Publication No. 8-279072

### BRIEF DESCRIPTION OF THE DRAWINGS

FIG. 1 is a perspective view showing an appearance of an article supply apparatus of one aspect of the present invention.

FIG. 2 is a schematic cross-sectional view showing an internal structure of the article supply apparatus in FIG. 1.

FIG. 3 is a perspective view of a coin insertion unit shown in FIG. 2, as viewed from a right side.

FIG. 4 is a perspective view of the coin insertion unit shown in FIG. 2, viewed from a left side.

FIG. 5 is an enlarged perspective view of a sorting portion shown in FIG. 3.

FIG. 6 is a schematic cross-sectional view of a vicinity of the sorting portion as viewed from a rear side toward a front side of the apparatus.

### DESCRIPTION OF EXEMPLARY EMBODIMENTS

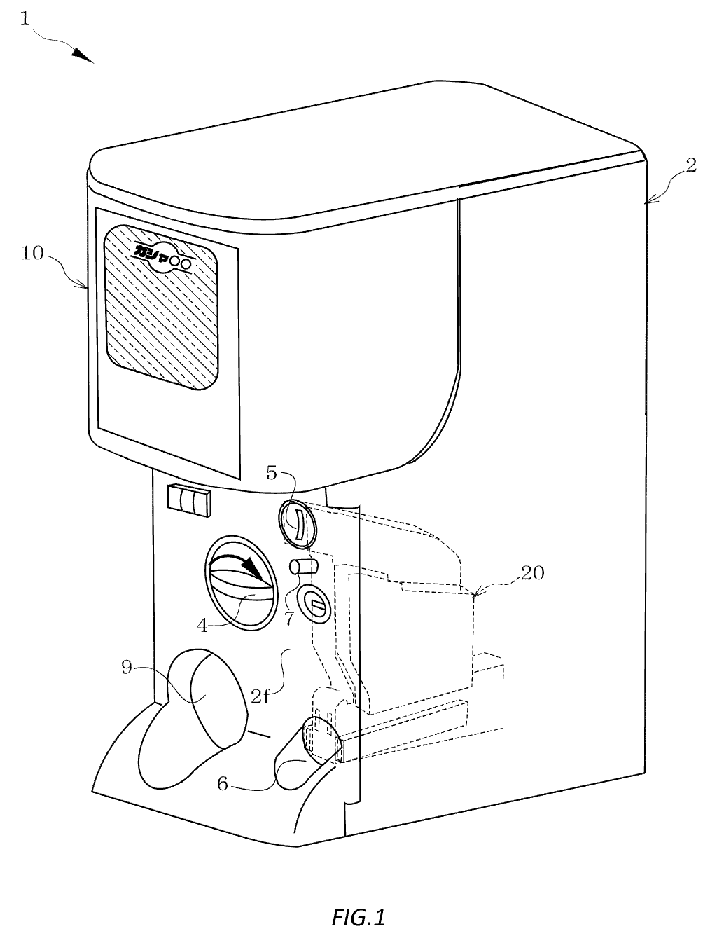

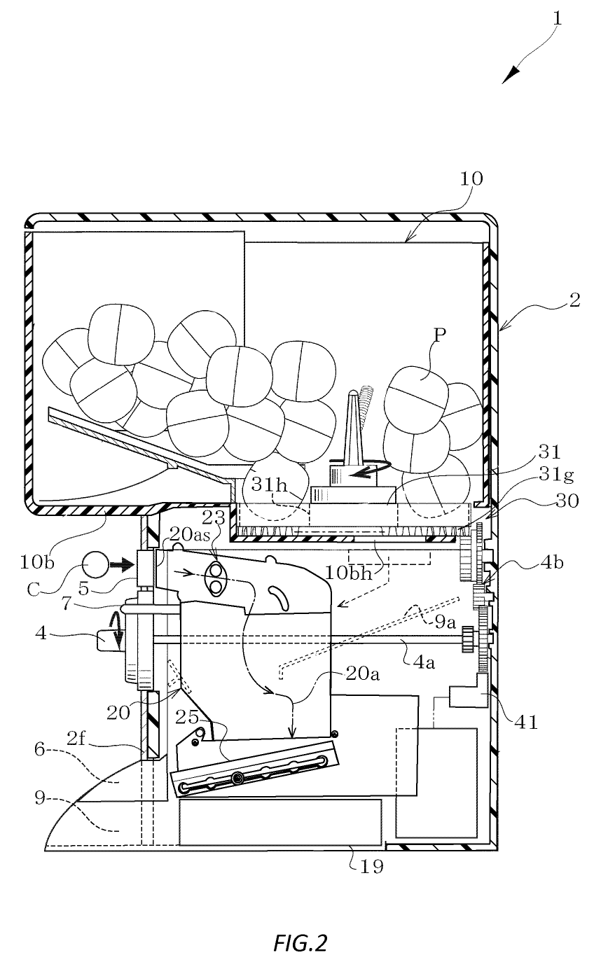

An article supply apparatus which is one aspect of the present invention will be described below with reference to the figure. FIG. 1 is a perspective view showing an appearance of an article supply apparatus 1 of the present aspect, and FIG. 2 is a schematic cross-sectional view showing an internal structure of the article supply apparatus 1.

The article supply apparatus 1 shown in FIG. 1 and FIG. 2 is an apparatus which is capable of supplying an article P of a capsule case of a spherical shape, in which toys or parts are accommodated, for example. More specifically, the article supply apparatus 1 includes: an accommodation portion 10 which is capable of accommodating a plurality of articles P in a random arrangement; a supply portion 30 which has a rotation disk 31 that is provided rotatably at a bottom portion 10b of the accommodation portion 10 and that is capable of randomly selecting and supplying the articles P one by one; and a lock portion 41 which locks the supply portion 30 to be inoperable, and the lock portion 41 is driven to release the lock on the condition that a coin C as a price is paid from an insertion portion 5. Then, in an unlocked state, an operation portion 4 provided on a front surface 2f is operated to rotate. In this manner, a gear train 4b provided at an edge side of a shaft 4a of the operation portion 4 rotates, and the rotation disk 31 is rotated via a rack gear 31g thereof. The article P held in a holding hole 31h of the rotation disk 31 falls at a passage hole 10bh provided in the bottom portion10b, and is supplied to a dispensing outlet 9 via an article passage portion 9a.

In the article supply apparatus 1, a coin insertion unit 20 is provided on the right side of the operation portion 4 (right side when the apparatus is faced). This coin insertion unit 20 is connected to the insertion portion 5 provided on the front surface 2f of a main body portion 2. Then, the coin C inserted from the insertion portion 5 passes through a passage portion 20a formed inside the coin insertion unit 20, and falls into and is held in a holding portion 25 on a lower side of the unit. In addition, in a case where a valid coin is inserted, when a predetermined amount is inserted and a predetermined operation is performed, the coin C held in the holding portion 25 is accommodated in a coin accommodation portion 19 provided, for example, below the holding portion 25. On the other hand, a configuration is made such that when a counterfeit coin is inserted, it is captured at a retention portion 23 provided in the passage portion 20a.

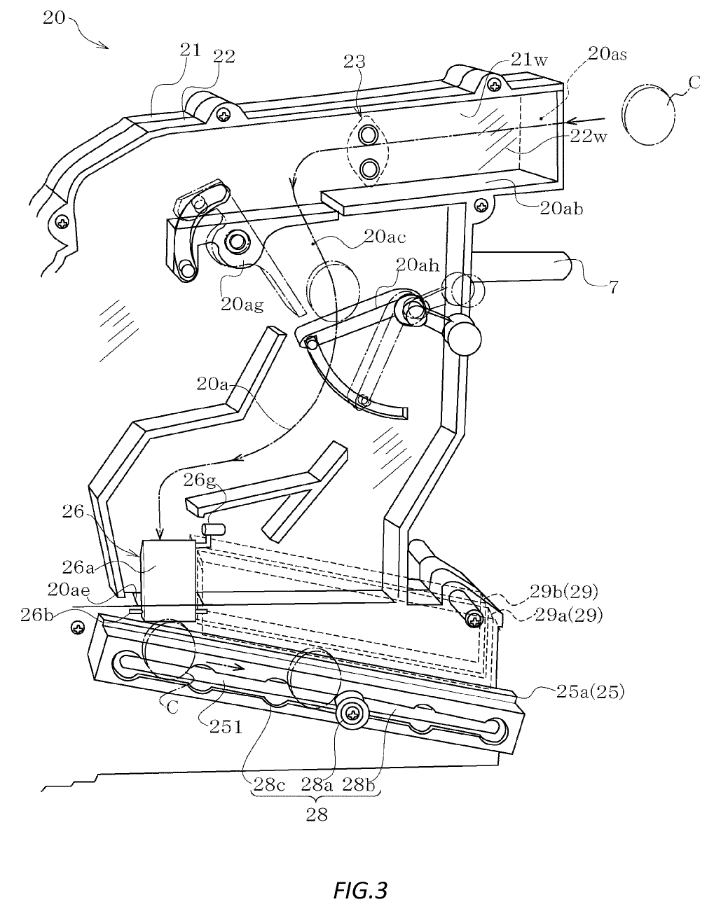

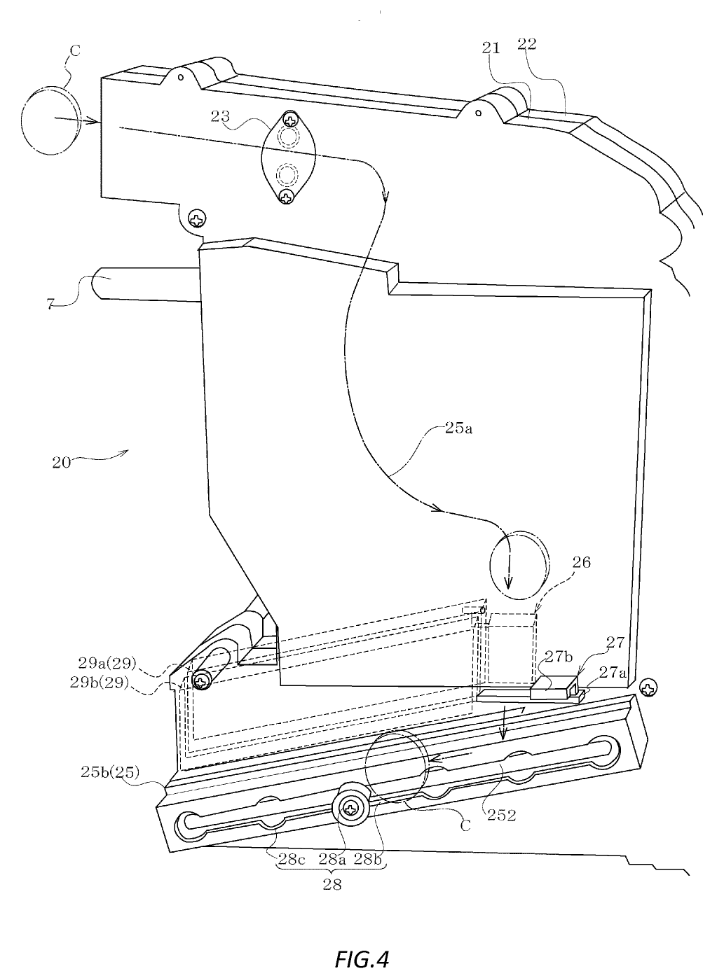

FIG. 3 is a perspective view of the coin insertion unit 20 shown in FIG. 2, as viewed from a right side. FIG. 4 is a perspective view of the coin insertion unit shown in FIG. 2, viewed from a left side. As shown in FIG. 3, the coin insertion unit 20 is a thin unit in which, for example, a left half case 21 and a right half case 22 are combined from the left and right direction, and left and right side walls thereof, which are a first side wall portion 21w and a second side wall portion 22w, face each other closely to form an internal space. Unlike the left half case 21 including the first side wall portion 21w, the right half case 22 including the second side wall portion 22w is formed, for example, of a light-transmitting material, and is configured such that the inside of the unit can be seen, as illustrated.

The coin insertion unit 20 has the passage portion 20a formed therein, from a start end portion 20as (right upper side in the Figure) connected to the insertion portion 5 to which the coin C is inserted, to an opening 20ae at a terminal end portion. The passage portion 20a is configured such that the coin C moves by gravity. For example, an initial coin introduction part including the start end portion 20as is provided with an inclination portion 20ab such that the coin C rolls, and is provided with a falling portion 20ac on a rear side of the inclination portion 20ab. The falling portion 20ac is provided with a first swing plate 20ag on an upper portion and a second swing plate 20ah on a lower portion; and both swing plates 20ag, 20ah rotate when the coin C is placed thereon, and assist the fall of the coin C and guide a movement direction of the coin C.

The opening 20ae at the terminal end portion of the passage portion 20a serves as an entrance to the holding portion 25 which holds the coin C. As shown in FIG. 3 and FIG. 4, the holding portion 25 is provided with a first holding portion 25a on a front side of the unit (right side when viewed from the front of the apparatus), and is provided with a second holding portion 25b having the same structure on a back side of the unit (left side when viewed from the front of the apparatus), and they face each other at positions on the front and back sides. Both of the first holding portion 25a and the second holding portion 25b are configured to be capable of holding the coin C. In addition, the sorting of the coins C into the first holding portion 25a and the second holding portion 25b is performed by a sorting portion 26 provided across an inside and an upper side of the opening 20ae.

As illustrated, the first holding portion 25a and the second holding portion 25b include a first passage portion 251 and a second passage portion 252 which are inclined toward a front surface 2f side (refer to FIG. 2). That is, the configuration is made such that the coin C which falls from the opening 20ae is movable toward the front surface 2f side by its own weight.

In addition, it is possible to determine setting of the number of coins C that are held in the first passage portion 251 and the second passage portion 252, by a setting portion 28 which is capable of engaging a movement of the coin C in an inclination direction. For example, the setting portion 28 has a slide opening 28b of a slit shape which is formed along the first passage portion 251 and the second passage portion 252 and is opened to an outer surface, and is provided with a position setting pin 28a which is movable in this slide opening 28b and protrudes into both passage portions 251, 252.

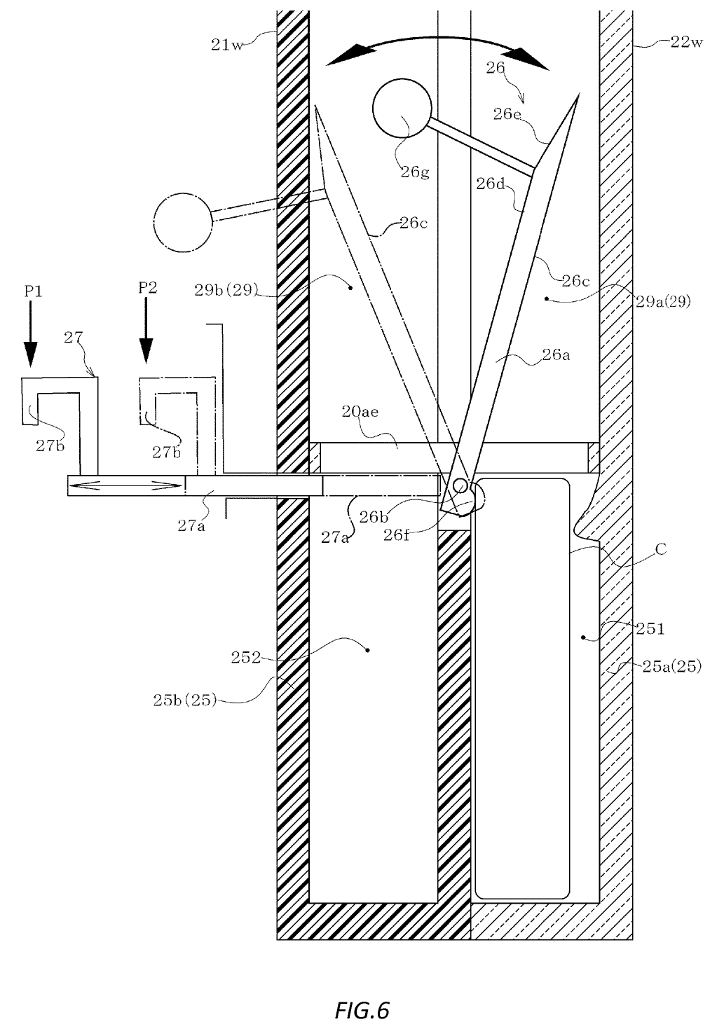

Further, the position setting pin 28a is configured to be capable of engaging in a plurality of large- diameter opening portions 28c which are formed at predetermined intervals in the slide opening 28b. That is, by engaging the position setting pin 28a in a predetermined large-diameter opening portion 28c, it is possible to set the number of coins C to a predetermined number. In addition, for the first holding portion 25a, a configuration is made such that the last (rearmost) coin C of a prescribed number of coins is positioned at a lower portion of the sorting portion 26 and contacts the lower portion of the sorting portion 26, as described later (refer to FIG. 6).

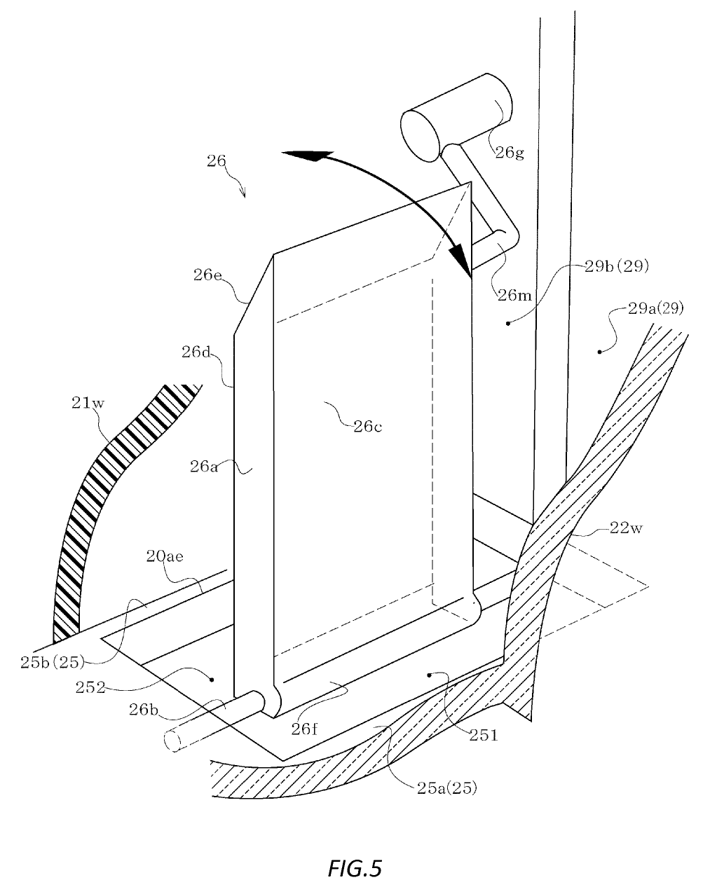

FIG. 5 is an enlarged perspective view of the sorting portion 26 shown in FIG. 3. As shown in FIG. 5, the sorting portion 26 includes: a plate portion 26a of a rectangular shape; a shaft portion 26b which rotatably supports the plate portion 26a; a weight 26g which is held by an arm 26m which projects from an end surface of the plate portion 26a; and an inclined surface 26e for directing which is formed on an upper portion of the plate portion 26a.

The sorting portion 26 includes: a first surface portion 26c, and a second surface portion 26d on the opposite side of the first surface portion 26c, for abutting the coins C that fall from above and sorting the coins C into the left and right. The first surface portion 26c guides the coin C that abuts this surface to be held on a first holding portion 25a side. On the other hand, the second surface portion 26d guides the coin C that abuts this surface to be held on a second holding portion 25b side. For example, in a free state, the sorting portion 26 is inclined by the weight 26g such that the first surface portion 26c faces upward (left side in FIG. 6), and guides the falling coin C to the first holding portion 25a side. On the other hand, under a predetermined condition described later (refer to FIG. 6), a rotation is performed such that the second surface portion 26d faces upward (right side in FIG. 6), thereby guiding the falling coin C to the second holding portion 25b side.

FIG. 6 is a schematic cross-sectional view of a vicinity of the sorting portion 26 as viewed from a rear side toward a front side of the apparatus. The sorting portion 26 is biased in the counterclockwise direction in FIG. 6 by the weight 26g, and is inclined such that an upper end part is in contact with the first side wall portion 21w in a free state in which no external force is applied. In this state, the coin C that falls from above abuts the first surface portion 26c, passes through the opening 20ae and falls into the first passage portion 251.

In the coins C that fall into the first passage portion 251, the last (rearmost) coin C of a prescribed number is held directly below the sorting portion 26 as illustrated. Then, by this last held coin C, the sorting portion 26 is maintained in a state of being rotated in the clockwise direction against the biasing force of the weight of 26g. That is, an upper end part of the coin C abuts a lower end portion 26f of the sorting portion 26, thereby maintaining the sorting portion 26 in a state in which an upper end portion thereof is close to a second side wall portion 22w side. In this state, it is possible to sort the coin C into the second holding portion 25b side. It should be noted that for a configuration in which the position of the coin C is regulated in the width direction thereof such that the coin C contacts the lower end portion 26f, the illustration shows a configuration in which a protrusion portion is provided on the second side wall portion 22w side. However, the configuration for this position regulation is not particularly limited as long as it can regulate the position of the coin C to the left side of the first passage portion 251 in the figure.

In addition, in a state in which the upper end portion of the sorting portion 26 is rotated to the second side wall portion 22w side, the inclination angle thereof is in a state of being closer to the vertical direction compared to a state of being inclined to a first side wall portion 21w side. However, at the upper end portion, the inclined surface 26e for directing the coin C to a second surface portion 26d side is formed, thereby making the movement of the coin C smooth.

The lower end portion 26f of the sorting portion 26 has a shape protruding toward a first passage portion 251 side below the shaft portion 26b. For example, as illustrated, it may be configured to have a protruding shape protruding toward the first passage portion 251 side, or to be bent to protrude toward the first passage portion 251 side.

In addition, the sorting portion 26 is configured to use the weight 26g for the biasing, but may be configured to use a biasing force of a magnet instead of the weight 26g.

In addition, on the second holding portion 25b side, a regulation portion 27 which is configured to be capable of opening and closing the opening 20ae to regulate sorting, is provided. This regulation portion 27 includes a horizontal plate portion 27a which is flat and which opens and closes the opening 20ae on the second holding portion 25b side, and an operation piece 27b which protrudes upward and laterally (left direction) from the horizontal plate portion 27a, and is provided to be slidable (reciprocally movable) from the back side of the unit in the unit thickness direction. In this regulation portion 27, the horizontal plate portion 27a is positioned in the second passage portion 252 directly below the opening 20ae, and can open and close the opening 20ae on the second passage portion 252 side. For example, as illustrated, when the regulation portion 27 is at a first position P1 (left side in the figure) away from the first holding portion 25a, the opening 20ae is opened, enabling the inserted coin C to be sorted. On the other hand, when the regulation portion 27 is at a second position P2 (right side in the figure) of being close to the first holding portion 25a, the opening 20ae on the second passage portion 252 side is closed, and the inserted coin C is not sorted into the second passage portion 252 but is sorted only into the first passage portion 251.

In addition, above the second passage portion 252 (second holding portion 25b), a discharge portion 29 (29b) is provided, which is configured parallel to the second passage portion 252 and has an upper end side and a lower end side that are opened. That is, the discharge portion 29 (29b) constitutes an inclined path that is opened to the front of the unit from the space in which the sorting portion 26 is provided (refer to FIG. 4). Accordingly, for example, when the regulation portion 27 is pushed to the second position P2 to close the opening 20ae on the second holding portion 25b side, the discharge portion 29 (29b) can discharge the coin C sorted to the second holding portion 25b side to a return port 6 (refer to FIG. 1 and FIG. 2). It should be noted that the discharge portion 29 (29a) is also provided above the first passage portion 251 (first holding portion 25a).

In addition, a return button 7 is provided below the insertion portion 5. For example, when a user wants return of the coin C which is already inserted, or the like, it is possible, by pressing the return button 7, to discharge the coins C held in the first holding portion 25a and the second holding portion 25b, to the return port 6.

As described above, in the article supply apparatus 1 of the present aspect, the portion which holds the inserted coins C, includes the first holding portion 25a and the second holding portion 25b, thereby making it possible to hold the coins C in a plurality of locations. In addition, a configuration for holding the coins C is made such that the sorting portion 26 is capable of sorting, for example, when the first holding portion 25a is holding a preset number of coins C, capable of sorting the coin C that is inserted thereafter to be held in the second holding portion 25b, thereby enabling a change such as an increase in number of coins capable of being held. This makes it possible to provide the article supply apparatus 1 which is capable of easily handling even a case where products with different prices are provided. Accordingly, with the present embodiment, it is possible to provide the article supply apparatus which easily handles a change in product price with improved convenience.

In the article supply apparatus 1 of the present aspect, the sorting portion 26 has a plate shape and includes the first surface portion 26c and the second surface portion 26d, thereby making it possible to smoothly sort the contacted coin C by the front and back surfaces. Further, the shaft portion 26b for rotation is provided on the lower portion side through which the coins C pass (fall), thereby making it possible to move the position of the upper end portion of the sorting portion 26 which determines the sorting orientation, by the weight of the coin C or the abutment of the coin C.

In addition, the inclined surface 26e which directs the coin C to the second surface portion 26d side is formed at the upper end portion of the sorting portion 26, thereby making it possible to easily guide the coin C to the side on which the inclined surface 26e is formed, for example, even when the inclination of the sorting portion 26 with respect to the vertical direction is small.

In addition, the sorting portion 26 is provided with means for biasing the rotation direction to a specific direction, such as the weight 26g or a magnet, thereby making it possible to set a prescribed position for the sorting portion 26 when no external force is applied. This makes it possible to set the first holding portion 25a, for example, as a main coin holding portion without adopting electrical control.

In addition, the position at which the sorting portion 26 is provided is near an upper portion of the first holding portion 25a and above the last (rearmost) set coin C, thereby making it possible to cause the last held coin C to be positioned at the opening 20ae which is a port of the first holding portion 25a, to which the coin falls. This makes it possible to cause the last coin C of a prescribed number to contact the lower end portion 26f of the sorting portion 26, and makes it possible to engage a rotational state of the sorting portion 26 at a predetermined position by the last coin C.

The article supply apparatus 1 of the present aspect is provided with the regulation portion 27 which can move between a position that regulates the sorting of the sorting portion 26 and a position that does not regulates the sorting (a state in which the coins are capable of being held in any of the first holding portion 25a or the second holding portion 25b), thereby making it possible to regulate a use of one of the holding portions. For example, it is possible to regulate the use of the second holding portion 25b by preventing the coin sorted to the second holding portion 25b from entering the second holding portion 25b, so as to be discharged. This makes it possible to switch the number of coins C that are held.

In the article supply apparatus 1 of the present aspect, the first holding portion 25a has the first passage portion 251, and the second holding portion 25b has the second passage portion 252, and the first passage portion 251 and the second passage portion 252 are configured to be inclined with respect to the horizontal, thereby making it possible to move and align the coins C by their own weight when the coins C are held in both of the holding portions. In this manner, the positions of a prescribed number of coins become accurate, and it is possible to easily and accurately detect the coin.

The article supply apparatus 1 of the present aspect includes the discharge portion 29 which is capable of discharging the inserted coin, thereby making it possible to discharge the coin C outside the machine, for example, when the insertion of the coin into the second holding portion 25b is regulated by the regulation portion 27. In addition, the discharge portion 29 is provided directly above the second holding portion 25b, thereby making it possible to discharge the coin C just before it is held in the second holding portion 25b.

In addition, in the article supply apparatus 1 of the present aspect, the first holding portion 25a and the second holding portion 25b are arranged to face each other at the front and back positions in the coin insertion unit 20, thereby making it possible to cause the operation of the regulation portion 27 to be a small operation, and making it possible to simplify the configuration and the structure.

In the article supply apparatus 1 of the present aspect, it is possible to easily change the setting of the setting portion 28 by removing the coin insertion unit 20 from the main body portion 2, and maintainability is good.

While an aspect of the present invention has been described hereinabove, the present invention can be appropriately altered in the scope of its technical idea. For example, the above aspect describes the configuration provided in the article supply apparatus 1 for selling the articles P of the capsule case, but the present disclosure is not limited to this, and can be applied to various apparatuses for selling articles.

### EXPLANATION OF REFERENCES

1: article supply apparatus

5: insertion portion

25a: first holding portion;

25b: second holding portion;

26: sorting portion;

26c: first surface portion

26d: second surface portion

26e: inclined surface

26g: weight

27: regulation portion

28: setting portion;

251: first passage portion

252: second passage portion

29: discharge portion;

C: coin;

P1: first position;

P2: second position.

What is claimed is:

1. An article supply apparatus comprising:
an insertion portion to which a coin is insertable;
a first holding portion and a second holding portion which are capable of holding the coins that are inserted; and
sorting portion which is provided between the insertion portion, and the first holding portion and the second holding portion, and which is capable of sorting the coin to a movement destination, wherein
each of the first holding portion and the second holding portion includes a setting portion which is capable of setting a number of at least one coin capable of being held, and
the sorting portion is configured, on a condition that the first holding portion is holding a set number of the coins, to be capable of sorting the coin that is inserted thereafter to be held in the second holding portion.

2. The article supply apparatus according to claim 1, wherein
the sorting portion includes a first surface portion and a second surface portion which faces the first surface portion,
the first holding portion is configured to be capable of holding the coin that contacts the first surface portion, and
the second holding portion is configured to be capable of holding the coin that contacts the second surface portion.

3. The article supply apparatus according to claim 2, wherein
the sorting portion is configured to be supported at a lower portion thereof by a shaft and to be rotatable.

4. The article supply apparatus according to claim 3, wherein
the sorting portion is configured to be rotatable when the coin that is inserted contacts the first surface portion or the second surface portion.

5. The article supply apparatus according to claim 4, wherein
the sorting portion is formed in a plate shape, and at an upper end portion thereof, an inclined surface which directs the coin to a side of the second surface portion, is formed.

6. The article supply apparatus according to claim 5, wherein
the sorting portion is provided with a weight at an upper portion thereof.

7. The article supply apparatus according to claim 5, wherein
the sorting portion is provided with a magnet at an upper portion thereof.

8. The article supply apparatus according to claim 1, wherein
the sorting portion is provided above the coin capable of being held at a rearmost position in the first holding portion.

9. The article supply apparatus according to claim 1, wherein
the sorting portion is provided near an upper portion of the first holding portion.

10. The article supply apparatus according to claim 1, further comprising:
a regulation portion which regulates sorting, wherein
the regulation portion is configured to be reciprocally movable in a horizontal direction.

11. The article supply apparatus according to claim 10, wherein
the sorting portion is configured to be capable of sorting the coin that is inserted when the regulation portion is at a first position, and not to capable of sorting the coin that is inserted when the regulation portion is at a second position.

12. The article supply apparatus according to claim 11, wherein
the sorting portion is configured to be capable of sorting the coins that are inserted, into the first holding portion and the second holding portion, when the regulation portion is at the first position, and is configured to be capable of sorting the coin that is inserted, only into the first holding portion, when the regulation portion is at the second position.

13. The article supply apparatus according to claim 12, wherein
the first holding portion includes a first passage portion, and the second holding portion includes a second passage portion, and
the regulation portion is configured to be partially positioned in the second passage portion when the regulation portion is at the second position.

14. The article supply apparatus according to claim 13, wherein
the second position is a position close to the first holding portion, and the first position is a position spaced apart from the first holding portion.

15. The article supply apparatus according to claim 1, further comprising:
a discharge portion which is capable of discharging the coin that is inserted, wherein
the sorting portion is configured not to be capable of sorting the coin that is to be discharged to the discharge portion.

16. The article supply apparatus according to claim 15, wherein
the sorting portion is configured to be in a state of not abutting the coin that is to be discharged to the discharge portion.

17. The article supply apparatus according to claim 1, wherein
the first holding portion and the second holding portion are provided inclined with respect to the horizontal at positions facing each other.

18. The article supply apparatus according to claim 5, wherein
the sorting portion is provided above the coin capable of being held at a rearmost position in the first holding portion.

19. The article supply apparatus according to claim 5, further comprising:
a discharge portion which is capable of discharging the coin that is inserted, wherein
the sorting portion is configured not to be capable of sorting the coin that is to be discharged to the discharge portion.

20. The article supply apparatus according to claim 5, wherein
the first holding portion and the second holding portion are provided inclined with respect to the horizontal at positions facing each other.
